(19) United States
(12) Patent Application Publication
(10) Pub. No.: US 2008/0158033 A1
(43) Pub. Date: Jul. 3, 2008

(54) DRIVING DEVICE FOR IMAGE DISPLAY SYSTEM

(76) Inventors: Yasuyuki Doi, Kyoto (JP); Makoto Hattori, Kyoto (JP); Hisao Kunitani, Kyoto (JP); Atsuhisa Kageyama, Osaka (JP); Tetsuro Oomori, Osaka (JP); Osamu Sarai, Osaka (JP); Tooru Suyama, Kyoto (JP); Kurumi Nakayama, Osaka (JP); Kazuya Matsumoto, Kyoto (JP)

Correspondence Address: MCDERMOTT WILL & EMERY LLP, 600 13TH STREET, NW, WASHINGTON, DC, 20005-3096, US

(21) Appl. No.: 11/965,279

(22) Filed: Dec. 27, 2007

(30) Foreign Application Priority Data
Dec. 28, 2006 (JP) 2006-356247
Nov. 14, 2007 (JP) 2007-295499

(51) Int. Cl. G09G 3/36

(52) U.S. Cl. 341/154

(57) ABSTRACT

A driving device for driving an image display system, which sequentially receives input image data corresponding to gradation of each pixel of a display image and outputs a driving voltage signal includes: an operation section for obtaining output image data of which a bit number is smaller than a bit number of the input image data based on input image data of a target pixel to be processed and input image data of a pixel in vicinity of the target pixel; a reference voltage generation section for generating a plurality of reference voltages of different levels; and a reference voltage selection section for selecting one of the plurality of reference voltages. The operation section is configured to obtain output image data of the target pixel so that a difference between the input image data and output image data of the target pixel and a difference between the input image data and output image data of the pixel in vicinity of the target pixel cancel out each other.

### BACKGROUND OF THE INVENTION

The present invention relates to a driving device for driving an image display system such as a liquid crystal display system and the like, which includes a D/A converter.

### DESCRIPTION OF THE RELATED ART

A driving device for driving an image display system such as a liquid crystal display system and the like includes, for example, a D/A converter which selects one of a plurality of reference voltages divided by resistance elements and then output the selected reference voltage. The selection is performed by switching switches according to image data.

However, the more the number of gradations (the bit number of image data) of an image to be display is, the more switches are needed. Specifically, for example, as the bit number of image data is increased by 1, the number of switches needed for one color is about double. For example, for 6-bit image data, 126 switches are needed. Accordingly, with increase in gradation number, a circuit scale and an area of switches occupying a semiconductor integrated circuit are increased, thus resulting in increase in fabrication costs. As the fineness of display images is increased, the above-described problem is more notable in a driving device including, for example, 480-800 D/A converters.

Then, a technique in which the number of switches is reduced by selecting adjacent two reference voltages from reference voltages corresponding to a smaller number by 1 bit than a gradation number and generating an average voltage of the two reference voltages by an amplifier has been known (see, for example, Japanese Laid-Open Publication No. 2000-183747 and Japanese Laid-Open Publication No. 2001-34234).

However, the above-described averaging procedure for two reference voltages is performed in an analog manner and therefore it is difficult to achieve high voltage accuracy. Moreover, in the above-described circuit configuration in which adjacent two reference voltages are averaged, a circuit size is reduced only by a 1 bit size.

### SUMMARY OF THE INVENTION

In view of the above-described points, the present invention has been devised and it is therefore an object of the present invention to keep high accuracy for a driving voltage output from a driving device for driving an image display system and reduce a circuit size or an area of a driving device occupying in a semiconductor integrated circuit in a simple manner.

To solve the above-described problems, an exemplary device according to the present invention is a driving device for driving an image display system, which sequentially receives input image data corresponding to gradation of each pixel of a display image and outputs a driving voltage signal, characterized in that the driving device includes: an operation section for obtaining output image data of which a bit number is smaller than a bit number of the input image data based on input image data of a target pixel to be processed and input image data of a pixel in vicinity of the target pixel; a reference voltage generation section for generating a plurality of reference voltages of different levels; and a reference voltage selection section for selecting one of the plurality of reference voltages, and the operation section is configured to obtain output image data of the target pixel so that a difference between the input image data and output image data of the target pixel and a difference between the input image data and output image data of the pixel in vicinity of the target pixel cancel out each other.

Thus, the number of different reference voltages can be reduced according to the bit number of output image data, so that a circuit size of the reference voltage selection sections can be reduced.

### BRIEF DESCRIPTION OF THE DRAWINGS

FIG. 1 is a block diagram illustrating a configuration of a driving device for driving an image display system according to Embodiment 1.

FIG. 2 is a table for explaining the relationship between input image data and driving voltage according to Embodiment 1.

FIG. 3 is a block diagram illustrating a specific configuration of a D/A converter 104 according to Embodiment 1.

FIG. 4 is a circuit diagram illustrating a more detailed configuration of the D/A converter 104 according to Embodiment 1.

FIG. 5 is a graph showing the relationship between input image data and driving voltage according to Embodiment 1.

FIG. 6 is a circuit diagram illustrating a detail configuration of a D/A converter 204 according to Modified Example 1 of Embodiment 1.

FIG. 7 is a graph showing the relationship between input image data and driving voltage according to Modified Example 1 of Embodiment 1.

FIG. 8 is a circuit diagram illustrating a detail configuration of a D/A converter 304 according to Modified Example 2 of Embodiment 1.

FIG. 9 is a graph showing the relationship between input image data and driving voltage according to Modified Example 2 of Embodiment 1.

FIG. 10 is a block diagram illustrating a configuration of a data operation circuit 405 according to Modified Example 3 of Embodiment 1.

FIG. 11 is a circuit diagram illustrating a detail configuration of a D/A converter 404 according to Modified Example 3 of Embodiment 1.

FIG. 12 is a table showing the relationship between input image data and driving voltage according to Modified Example 3 of Embodiment 1.

FIG. 13 is a graph showing the relationship between input image data and driving voltage according to Modified Example 3 of Embodiment 1.

FIG. 14 is a block diagram illustrating a configuration of a data operation circuit 505 according to Modified Example 4 of Embodiment 1.

FIG. 15 is a circuit diagram illustrating a detail configuration of a D/A converter 504 according to Modified Example 4 of Embodiment 1.

FIG. 16 is a table showing the relationship between input image data and driving voltage according to Modified Example 4 of Embodiment 1.

FIG. 17 is a graph showing the relationship between input image data and driving voltage according to Modified Example 4 of Embodiment 1.

FIG. 18 is a block diagram illustrating a configuration of a data operation circuit 605 according to Embodiment 2.

FIG. 19 is a circuit diagram illustrating a detail configuration of a D/A converter 604 according to Embodiment 2.

FIG. 20 is a table for explaining the relationship between input image data and driving voltage according to Embodiment 2.

FIG. 21 is a graph showing the relationship between input image data and driving voltage according to Embodiment 3.

FIG. 22 is a block diagram illustrating a configuration of a data operation circuit 705 according to Embodiment 3.

FIG. 23 is a circuit diagram illustrating a detail configuration of a D/A converter 704 according to Embodiment 3.

FIG. 24 is a table for explaining the relationship between input image data and driving voltage according to Embodiment 3.

FIG. 25 is a graph showing the relationship between input image data and driving voltage according to Embodiment 3.

FIG. 26 is a block diagram illustrating a configuration of a data operation circuit 805 according to Embodiment 4.

FIG. 27 is a block diagram illustrating a configuration of a data operation circuit 905 according to Embodiment 5.

FIG. 28 is a block diagram illustrating a configuration of a data operation circuit 935 according to Embodiment 7.

FIG. 29 is a timing chart showing operation of each member according to Embodiment 7.

FIG. 30 is a block diagram illustrating a configuration of a data operation circuit 955 according to a modified example of Embodiment 7.

FIG. 31 is a diagram illustrating a configuration of a driving device according to Embodiment 8 and the order of carry over data transfer therein.

FIG. 32 is a diagram illustrating a modified example of Embodiment 8.

FIG. 33 is a block diagram illustrating a configuration of a data operation circuit 105 according to the modified example of Embodiment 8.

FIG. 34 is a view illustrating carry over data transfer path according to Embodiment 8 and the modified example of Embodiment 8.

FIG. 35 is a block diagram illustrating a configuration of a driving device for driving an image display system according to another modified example.

### DESCRIPTION OF THE PREFERRED EMBODIMENTS

Hereafter, as embodiments of the present invention, exemplary driving devices for driving an image display system which outputs a driving voltage corresponding to 6-bit image data will be explained with reference to the accompanying drawings. In the following embodiments, each component having substantially the same function is identified by the same reference numeral and therefore the description thereof will be omitted.

### Embodiment 1

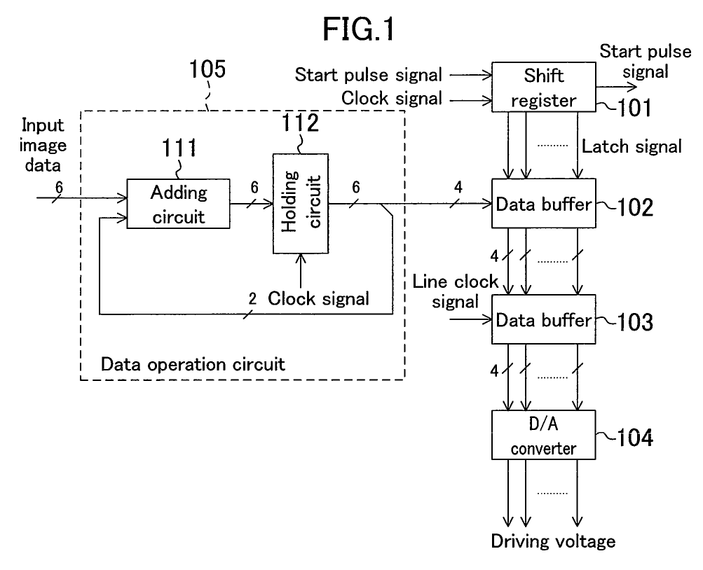

As shown in FIG. 1, for example, a driving device according to a first embodiment of the present invention includes a shift register 101, data buffers 102 and 103, a D/A converter 104 and a data operation circuit 105.

The shift register 101 receives a start pulse signal and a clock signal and outputs a latch signal to be sequentially shifted.

The data buffer 102 holds image data sequentially output from the data operation circuit 105 pixel by pixel according to the latch signal.

The data buffer 103 holds respective image data corresponding to a plurality pixels held in the data buffer 102 as one lump according to a line clock signal.

The D/A converter 104 outputs a driving voltage according to each image data held in the data buffer 103. A detail configuration of the D/A converter 104 will be described later.

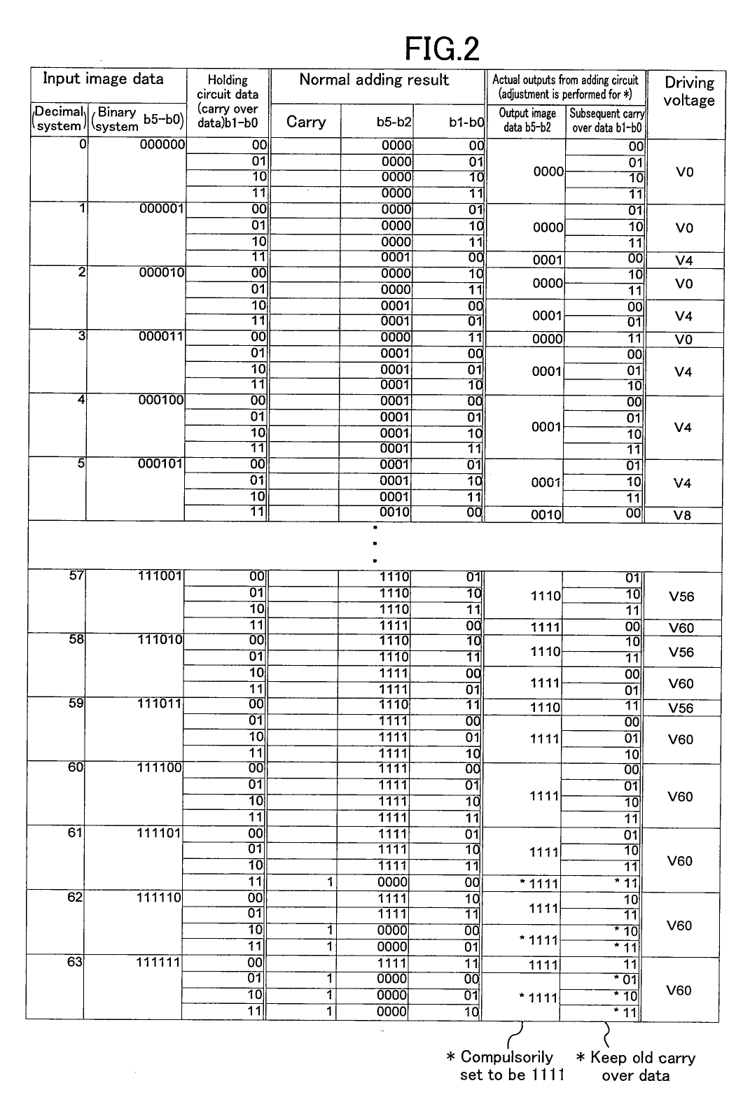

The data operation circuit 105 includes an adding circuit 111 and a holding circuit 112 (for example, flipflop). As shown in FIG. 2, data (carry over data) of 2 bits (b1 and b0) held in the holding circuit 112 is added to input image data of 6-bits (b5 through b0). Then, high order 4 bits (b5 through b2) of an adding result is output and low order 2 bits (b1 and b0) are held as subsequent carry over data in the holding circuit 112. That is, as for 6-bit input image data, 4-bit image data is output and low order 2 bits are sequentially carried over and added to image data of a subsequent pixel. However, as indicated by * in FIG. 2, when a carry (overflow) from the highest bit (b5) is generated at the time of adding, values of high order 4 bits (b5 through b2) of an adding result to be output from the adding circuit 111 are all 1 and, as low order 2 bits, values of old carry over data are held as subsequent carry over data (or holding new low order 2 bits may be suppressed and old values may be held in the holding circuit 112). In FIG. 1, the purpose of once holding high order 4 bits of an adding result in the holding circuit 112 is, for example, to adjust output timing. If timing is not a problem, the low bits do not have to be held.

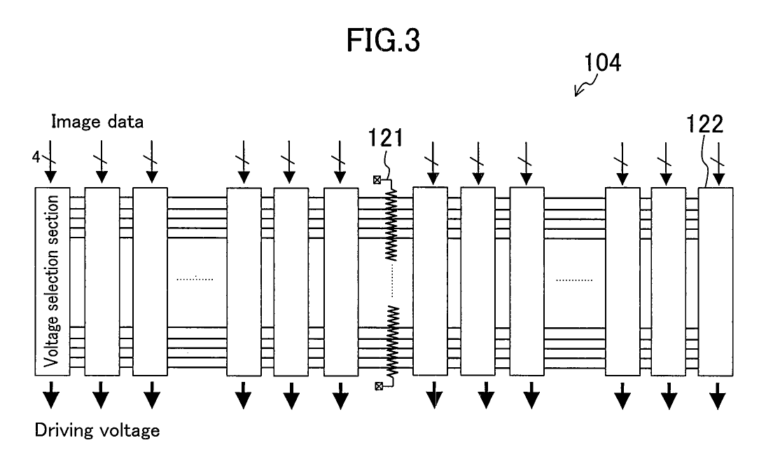

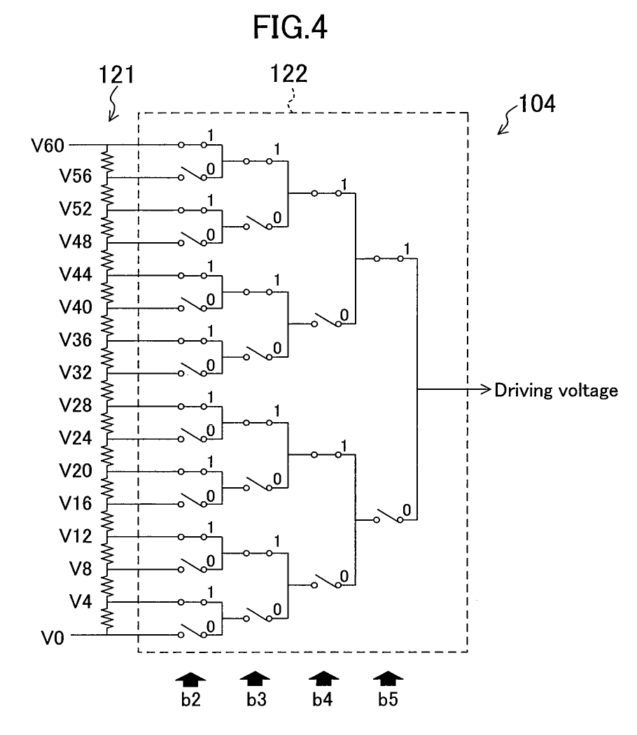

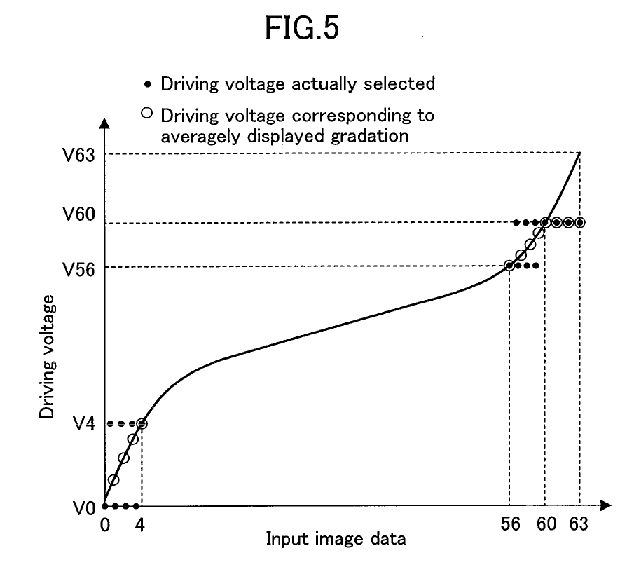

The 4-bit image data output from the data operation circuit 105 is received by the D/A converter 104 via the data buffers 102 and 103 and a driving voltage is output. As shown in FIG. 3, for example, the D/A converter 104 includes a reference voltage generation circuit 121 for generating reference voltages of plurality levels and a plurality of voltage selection sections 122 corresponding to pixels, respectively. More specifically, as shown in FIG. 4, for example, the reference voltage generation circuit 121 generates reference voltages V0, V4, V8, V12, . . . V60 of 16 levels in total such that one reference voltage is generated for every four reference voltages from V0 through V63 corresponding to 6-bit (64-gradation) image data. For example, the reference voltages V0 through V63 are reference voltages set to correspond to gradations 0 through 63, respectively, according to gamma characteristics which have been set beforehand as shown in FIG. 5. Each of the voltage selection sections 122 is configured to select one of the reference voltages of 16 levels by switching switches according to 4-bit (b5 through b2) image data output from the data operation circuit 105 and then output the selected reference voltage as a driving voltage (image signal) of each pixel.

In the driving device having the above-described configuration, for 6-bit (64-gradation) input image data, a driving voltage is selected from 16 levels based on 4-bit image data. In this case, for example, in the example shown in FIG. 2 and FIG. 5, when low order 2 bits is 00 (2) (in which “(2)” at the end indicates that the value is represented in the binary system), such as when a value of input image data is 000000 (2) or 000100 (2), accurate reference voltages V0 and V4 are output. On the other hand, assuming that as input image data, a value such as 000001 (2) including 01 (2) as low order 2 bits is consecutively received, V0 is output for 3 of 4 pixels and V4 is output for the other 1 of the 4 pixels. Then, if the 4 pixels are adjacent to one another, a display which averagely (stochastically) looks like a display at a gradation corresponding to V1 is performed.

In the same manner, when a value such as 000010 (2) including 10 (2) as low order 2 bits, a value such as 000011 (2) including 11 (2) as low order 2 bits or the like is consecutively received, V0 is output for 2 or 1 of 4 pixels and V4 is output for the other 2 or 3 of the 4 pixels. Then, if the 4 pixels are adjacent to one another, a display which averagely looks like a display at a gradation corresponding to V2 or V3 is performed. In the above-described example, for convenience purpose, the example where the same value is consecutively received has been described. However, even when values of input image data vary for pixels, the mechanism that between adjacent pixels, a value corresponding to low order 2 bits is adjusted and a display at a gradation corresponding to 6 bits is averagely performed is applied in the same manner.

As described above, after consideration of a value of low order 2 bits by the data operation circuit 105, a bit number of image data is reduced from 6 bits to 4 bits. Thus, a high gradation display can be performed using only 30 switches per 1 pixel for selecting a reference voltage.

A method for extracting 4-bit image data from an adding result for 6-bit image data is not limited to the above-described method, but the extraction may be performed by round off or the like.

As for carry over data, it is not necessary to hold an old value even when a carry from the highest bit occurs. Specifically, in the case where a number of pixels causing a carry consecutively appear, even if carry over data is held before and after such pixels, the effect of averagely performing a display close to a gradation display corresponding to 6 bits is reduced. Accordingly, there might be cases where image quality is not very much changed depending on how frequently such pixels appear. Moreover, as for carry over data after a number of pixels causing a carry have consecutively appeared, whatever a value is (e.g., a value uniformly updated by an adding result, a random number value or the like), if adding of carry over data is performed for subsequent pixels in the above-described manner, the effect of averagely displaying a gradation corresponding to 6 bits can be achieved as the same effect can be achieved whatever an initial value for a pixel at an end portion of a display is.

### Modified Example 1 of Embodiment 1

Consequently, for gradations 0 through 60, the driving device of the above-described first embodiment displays 61 different gradations. However, for gradations 60 through 63, because values of high order 4 bits (b5 through b2) as results of adding all become 1 when a carry occurs from the highest bit (b5) at the time of adding, the driving device uniformly performs a display at gradation 60. That is, an upper limit of gradation is 60.

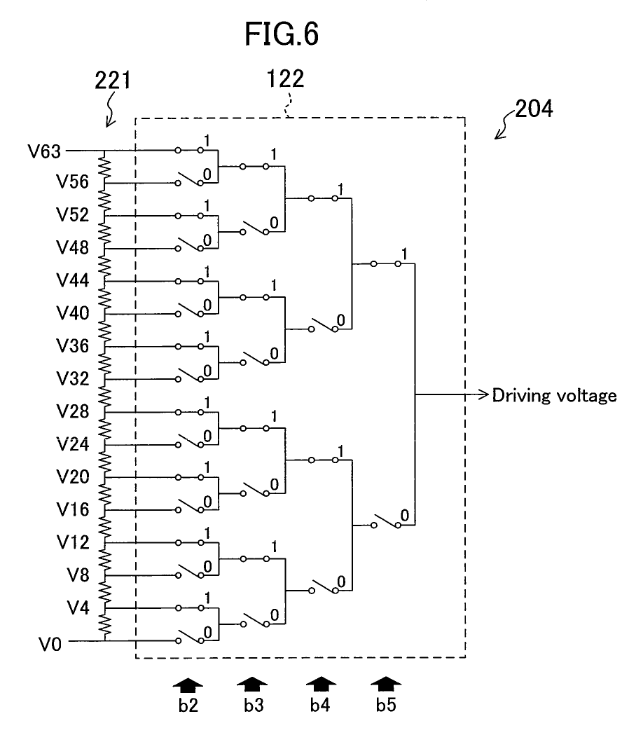

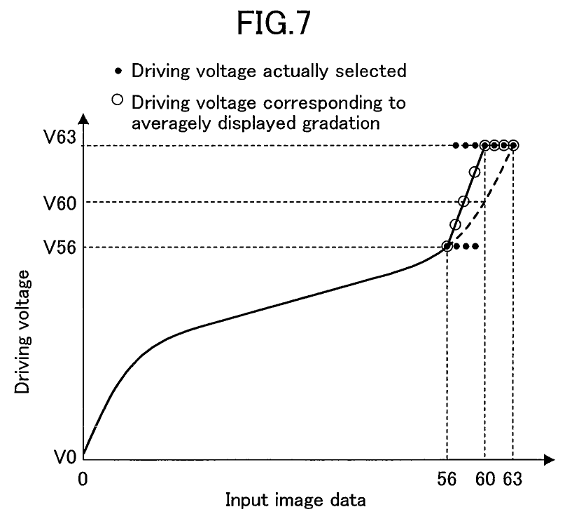

To make the brightest gradation to be gradation 63, a D/A converter 204 including a reference voltage generation circuit 221 shown in FIG. 6 and FIG. 7 may be provided so that only a highest reference voltage becomes V63. In this case, for gradations 56 through 60, image data is displayed at a slightly higher gradation, compared to the case where a bit number of image data is 6 bits, and for gradations 60 through 63, image data is uniformly displayed at gradation 63. That is, for gradations 60 through 63, there is no gradation difference but a brightest display is sufficiently performed.

### Modified Example 2 of Embodiment 1

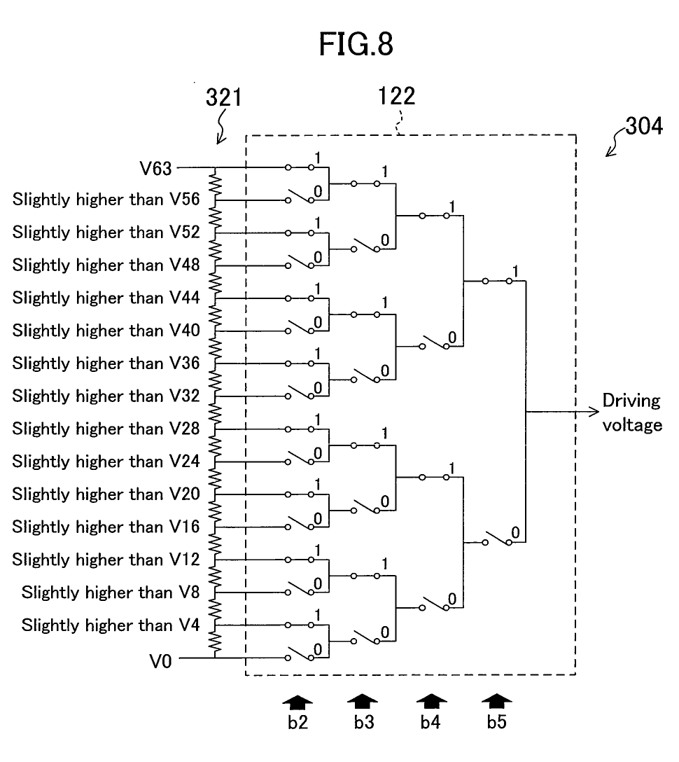

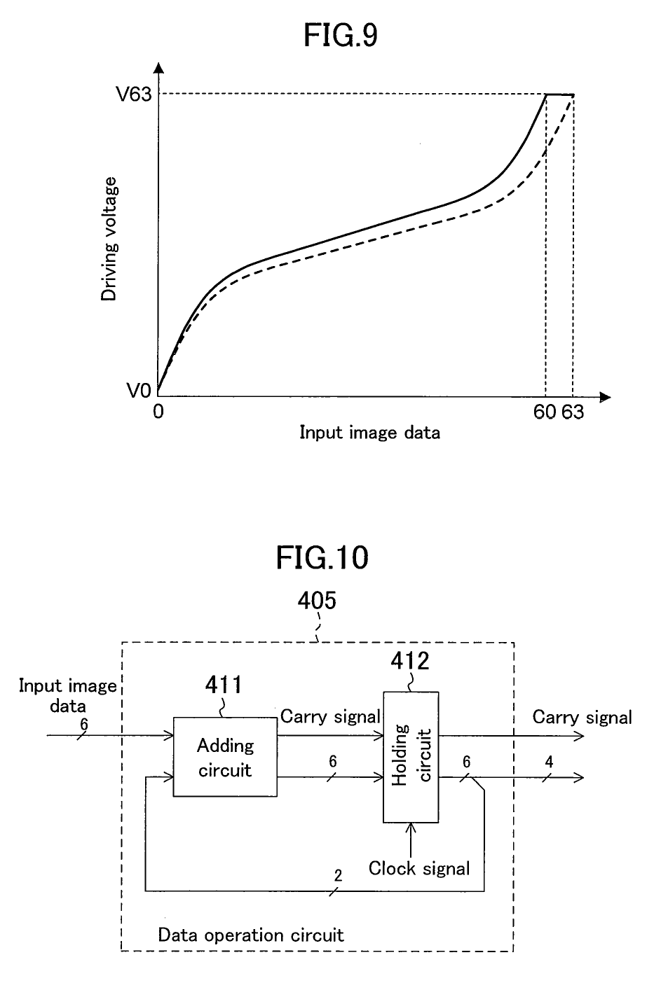

As shown in FIG. 8 and FIG. 9, for example, a D/A converter 304 including a reference voltage generation circuit 321 may be provided to set the highest reference voltage to be V63, thereby making reference voltages between V0 through V63 slightly higher. In this case, a brightest display is sufficiently performed and also a difference in rate of change in gamma curve between Modified Example 2 and the case where the bit number of image data is 6 bits can be suppressed to a low level.

This modified example is not limited to making reference voltages V0 through V63 corresponding to all gradations to be slightly higher. For example, only a reference voltage equal to a certain voltage level and higher voltages than the level, for example, reference voltages V40 through V63 may be made slightly higher.

### Modified Example 3 of Embodiment 1

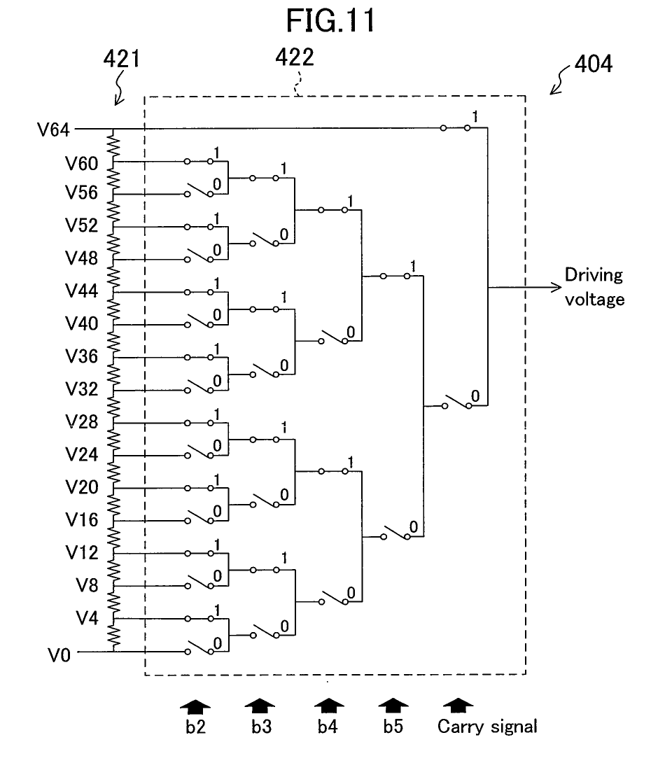

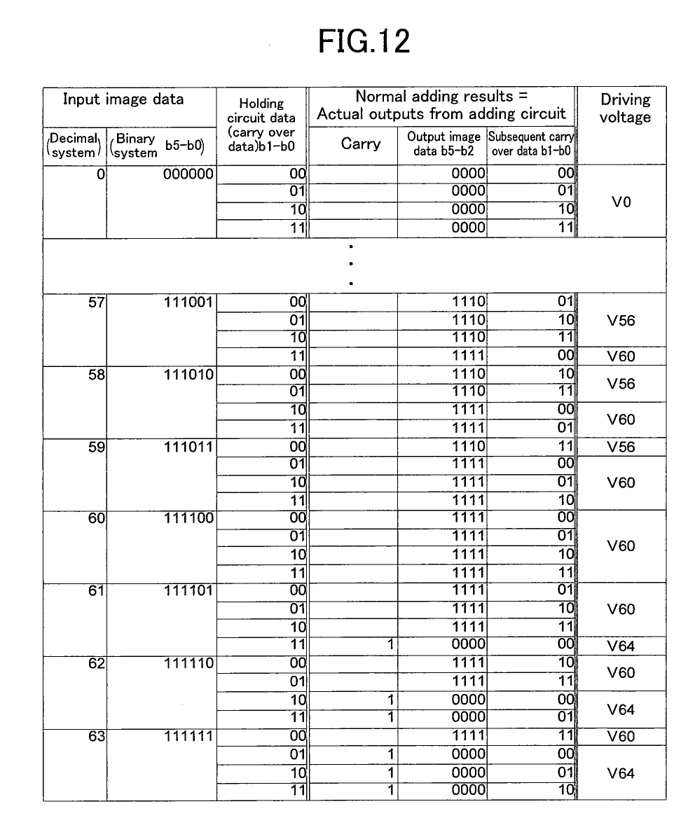

As shown in FIG. 10, for example, a data operation circuit 405 including an adding circuit 411 for performing normal adding operation and outputting an adding result and a carry signal and a holding circuit 412, and a D/A converter 404 including a reference voltage generation circuit 421 and voltage selection sections 422 shown in FIG. 11 may be used. Specifically, as shown in FIG. 12, the adding circuit 411 outputs a carry signal and at least low order 2 bits of an adding result of input image data and carry over data when a carry occurs, and the holding circuit 412 carries over low order 2 bits of the adding result to a subsequent adding at each time. The D/A converter 404 outputs V64 according to the carry signal.

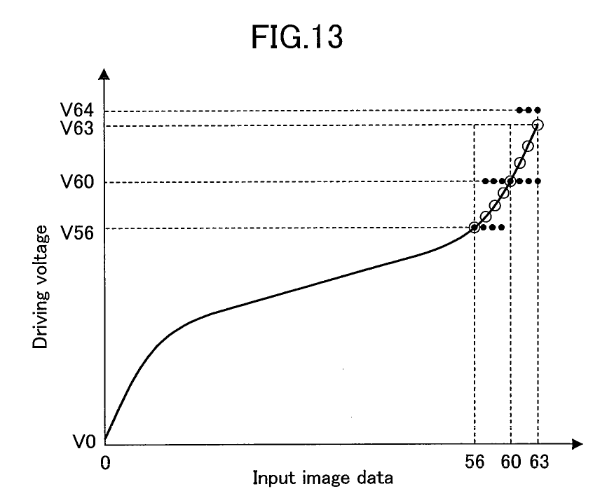

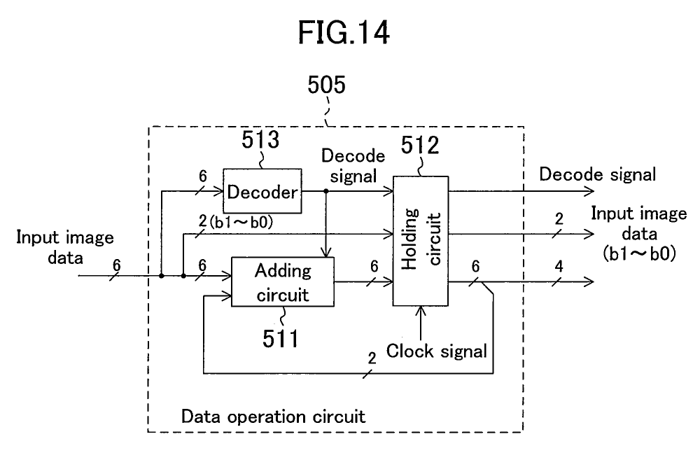

In this manner, when a carry occurs due to adding, i.e., when an adding result exceeds 63, V64 is output, so that as shown in FIG. 13, V60 or V64 is output also for gradations 60 through 63 at predetermined frequency in the same manner as in the case of gradations 56 through 59 or the like and a display at a gradation corresponding to 6 bits can be averagely performed.

The present invention is not limited to the above-described method in which whether or not to output V64 is controlled according to a carry signal. Similar control can be performed also, for example, by decoding input image data and/or carry over data, combining such decoding and adding, and the like. Specifically, for example, when high order 4 bits (b5 through b2) of input image data are all 1 and a carry occurs from a second lowest order bit (b1) due to adding to carry over data, V64 may be output.

### Modified Example 4 of Embodiment 1

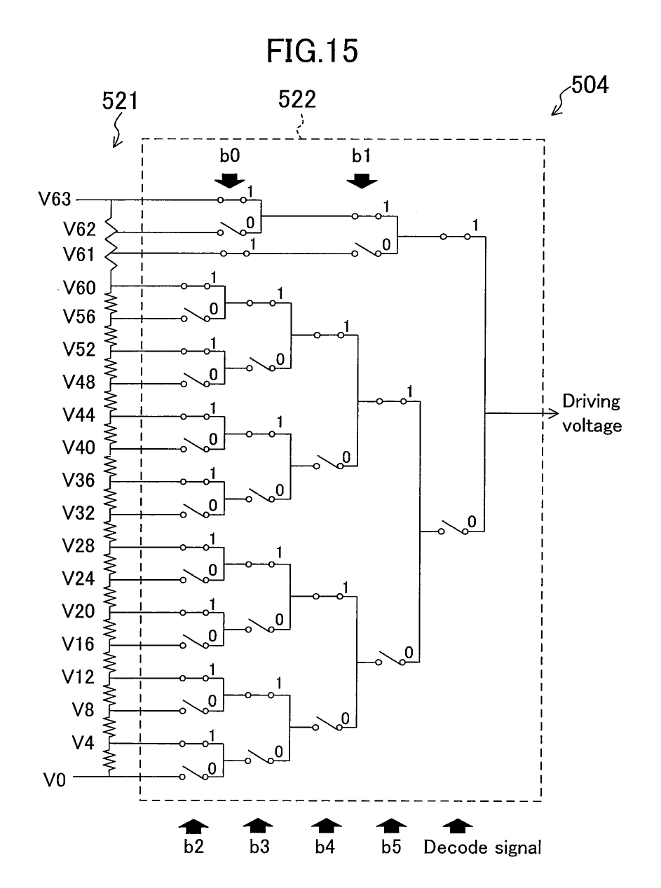

A driving device according to a fourth modified example of the first embodiment may be configured so that V61 through V63 are actually generated as reference voltages and then when a value of input image data is 61 or more, one of the reference voltages V61 through V63 is output. Specifically, the driving device of the fourth modified example includes a data operation circuit 505 having an adding circuit 511, a holding circuit 512 and a decoder 513 and a D/A converter 504 having a reference voltage generation circuit 521 and voltage selection sections 522 shown in FIG. 15.

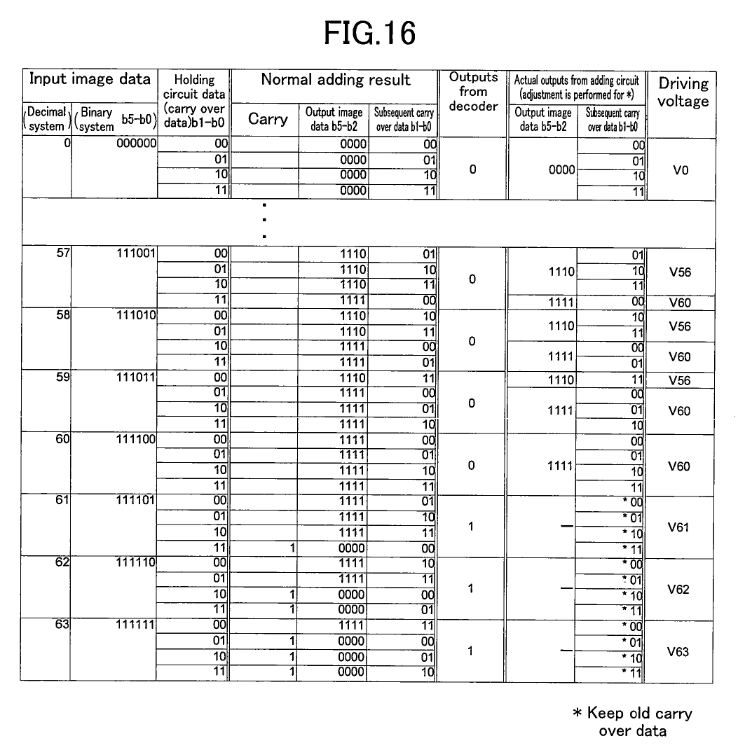

As shown in FIG. 16, the decoder 513 outputs a decode signal which becomes 1 when a value of input image data is 61 or more. More specifically, for example, when high order 4 bits (b5 through b2) are all 1 and one or both of low order 2 bits (b1 and b0) are 1, the decoder 513 outputs 1.

The adding circuit 511 adds input image data to carry over data in the same manner as the adding circuit 111 of the first embodiment. However, as indicated by * in FIG. 16, when the decode signal is 1 (i.e., when a value of input image data is 61 or more), as low order 2 bits, values of old carry over data are output as they are and are used as subsequent carry over data (or holding of new low order 2 bits may be suppressed and old values may be held in the holding circuit 512). Moreover, when the decode signal is 1, in the D/A converter 504, selection of a reference voltage is performed only by low order 2 bits of input image data in the following manner and therefore, whatever value may be output for high order 4 bits.

The holding circuit 512 holds an adding result for 6-bit image data, outputs low order 2 bits as subsequent carry over data to the adding circuit 511, and outputs high order 4 bits for D/A conversion. Furthermore, the holding circuit 512 once holds a decode signal from the decoder 513, low order 2 bits (before adding) of input image data and then outputs them.

The D/A converter 504 outputs a driving voltage based on the decode signal, the high order 4 bits of the adding result, and low order 2 bits of the input image data which have been output from the data operation circuit 505. More specifically, when the decode signal is 0 (input image data is one of 0 through 60), corresponding one of reference voltages V0 through V60 is output as in the first embodiment. On the other hand, when a decode signal is 1 (input image data is one of 61 through 63), corresponding one of V61 through V63 is output according to low order 2 bits (b1 and b0) of the input data.

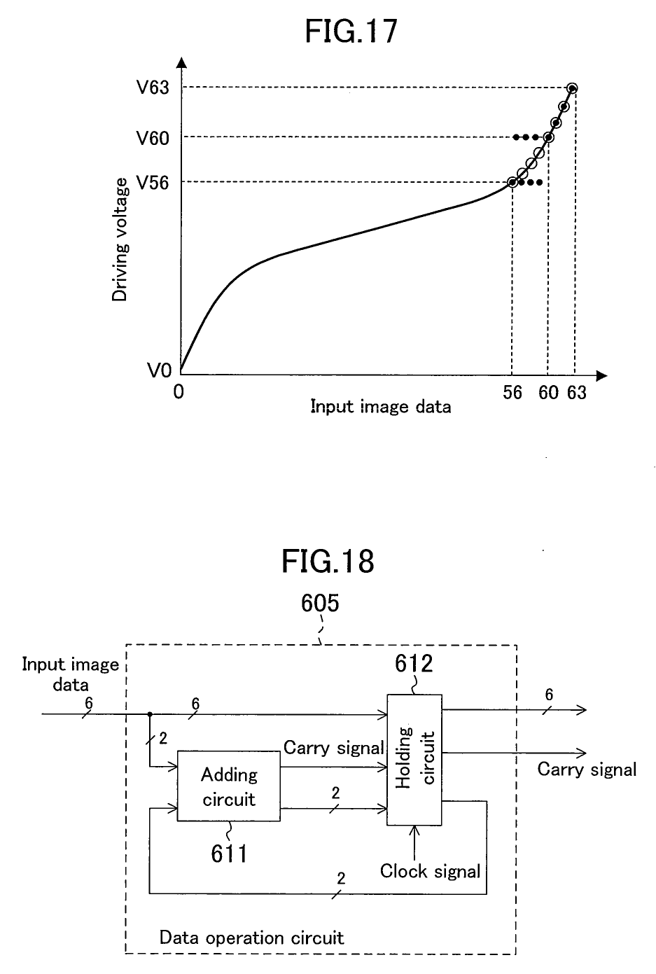

In the driving device having the above-described configuration, as shown in FIG. 17, display can be performed for pixels of input image data 61 through 63 not in an average gradation but in a gradation corresponding to 6-bit image data including brightest gradation for each pixel. In this case, although a bit number of image signal data to be received by the D/A converter 504 is 6 bits, a gradation display corresponding to 6 bits is averagely performed based on the high order 4 bits of the adding result, as in the first embodiment when input image data is one of 0 through 60. Thus, the number of switches used in the D/A converter 504 can be suppressed to a small number.

As described in the first embodiment, when input image data is one of 60 through 63, old values for carry over data do not have to be held.

In the above-described example, when input image data is one of 0 through 60, corresponding one of reference voltages V0 through V60 is output. However, one of V61 through V63 may be output according to an adding result of carry over data. In that case, carry over data to a subsequent pixel may be cleared.

Moreover, when a value of input image data is one of 61 through 63, according to an adding result of carry over data, corresponding one of reference voltages V61 through V66 (a maximum value of the adding result is 111111 (2)+11 (2)) or the like may be output.

### Embodiment 2

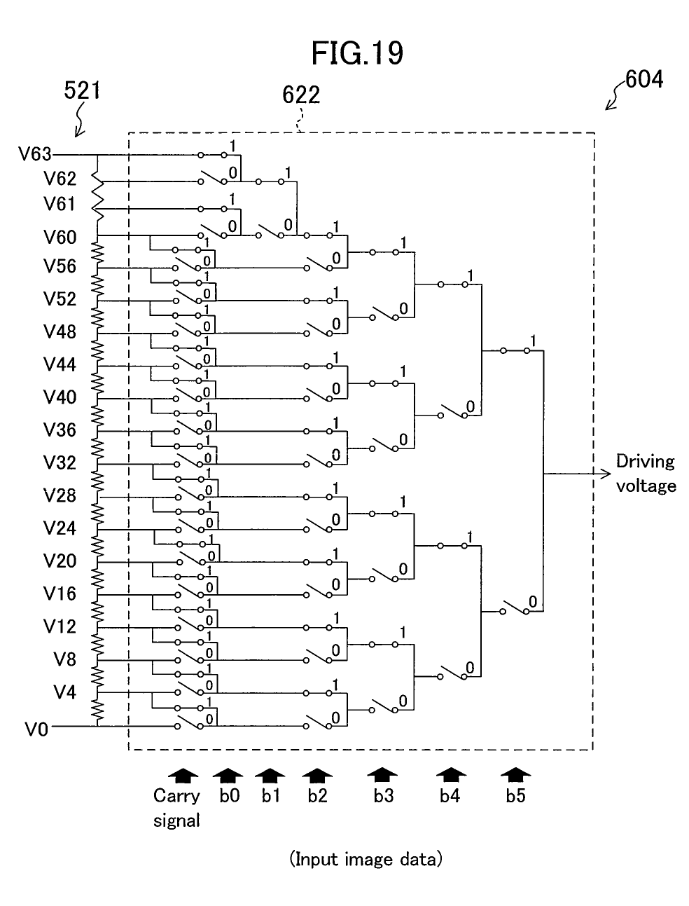

An example where carry over data is added only to low order 2 bits of 6 bits of input image data in a sequential manner will be described. As shown in FIG. 18, a driving device according to Embodiment 2 of the present invention includes a data operation circuit 605 having an adding circuit 611 and a holding circuit 612 and a D/A converter 604 having a reference voltage generation circuit 521 and voltage selection sections 622 shown in FIG. 19.

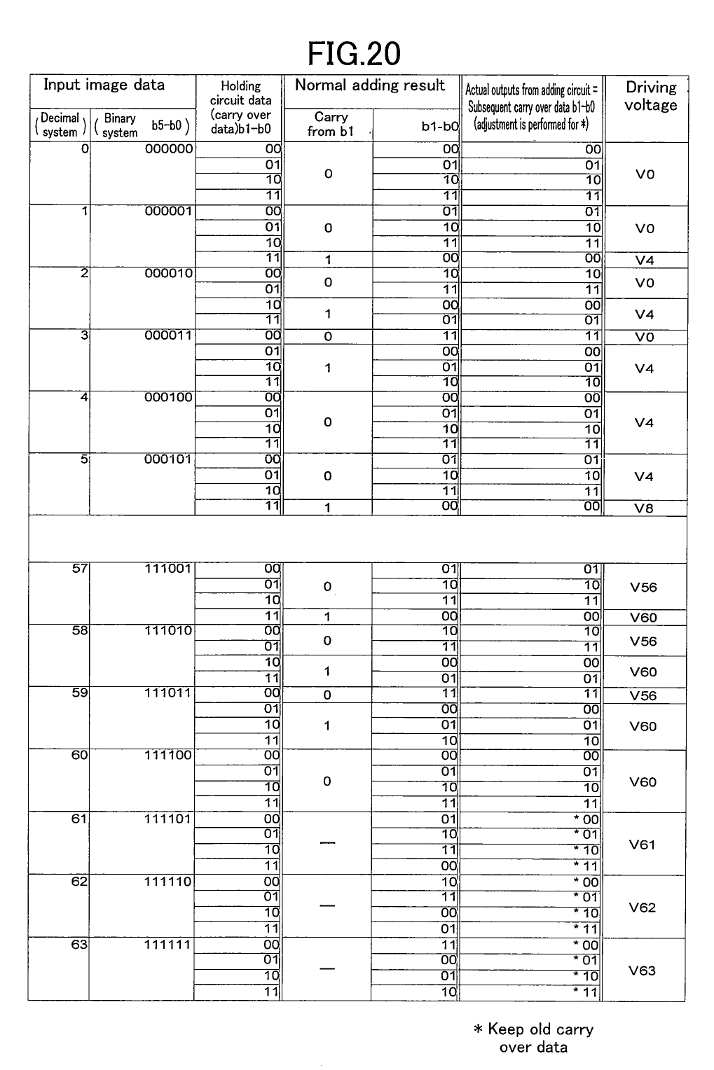

As shown in FIG. 20, the adding circuit 611 sequentially adds 2 bit carry over data to low order 2 bits of input image data. The adding circuit 611 outputs a carry signal when a carry occurs from a second lowest bit (b1) of an adding result.

The holding circuit 612 holds a 2 bit adding result and carry over the result to subsequent adding. Furthermore, the holding circuit 612 holds the carry signal and 6 bit input image data as they are and outputs them.

The D/A converter 604 selects, in principle, a reference voltage, based on high order 4 bits (b5 through b2) of the input image data, and, furthermore, selects a reference voltage of 1 level higher gradation when the carry signal is 1. For gradation 60 or higher, corresponding one of reference voltages V61 through V63 is selected by low order 2 bits of the input image data.

An image signal output from this driving device is the same as the image signal described in Modified Example 4 of Embodiment 1. Specifically, when input image data is one of 0 through 60, corresponding one of reference voltages V0 through V60 which is the same reference voltage obtained based on high order 4 bits of a result of adding all 6 bits of input image data to carry over data, is output based on the high order 4 bits of the input image data and the carry signal output when carry over data is added to low order 2 bits. In the case where input image data is one of 61 through 63, one of reference voltages V60 through V63 selected according to low order 2 bits of the input image data passes via a series of switches which are turned ON when high order 4 bits of the input image data are all 1, so that the selected reference voltage is output as in the case where it is output via switches which are turned ON by the decode signal.

When the driving device has a configuration in which one of 2 level reference voltages is selected in the voltage selection sections 622 based on the carry signal output from the adding circuit 611 for 2 bits adding, the number of switches provided in the D/A converter 604 is increased while a circuit size of the adding circuit 611 is reduced. However, compared to the case where one of 64 level reference voltages is selected based on 6 bit image data, the number of necessary switches can be reduced.

The above-described configuration in which one of 2 level reference voltages is selected based on a carry signal obtained when carry over data is added to low order bits of input image data is not limited to application to a driving device capable of outputting reference voltages V61 through V63, but may be applied to the driving devices of Embodiment 1, Modified Examples 1 through 3 and the like.

In Embodiment 2, one of reference voltages V61 through V63 may be selected by the decode signal of Modified Example 4 of Embodiment 1.

### Embodiment 3

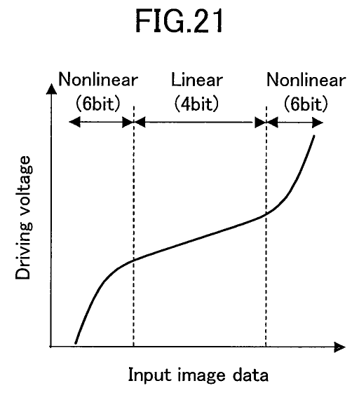

The range for which selection of a reference voltage using 6 bit image data is performed not limited to gradations 61 through 63, but may be performed for other gradations such as a gradation range in which a gradient change of a γ curve is large according to required gradation accuracy, resolution and the like. Also, as shown in FIG. 21, selection of a reference voltage may be performed for a plurality of gradation ranges. Moreover, not only a gradation range selected using 6 bit image data but also a gradation range selected using 5 bit image data may be provided.

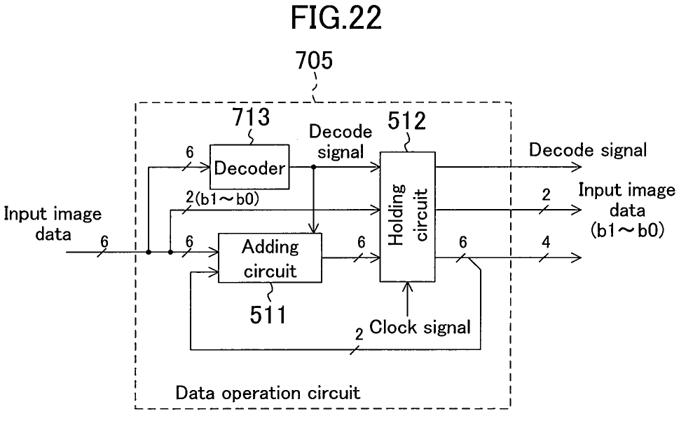

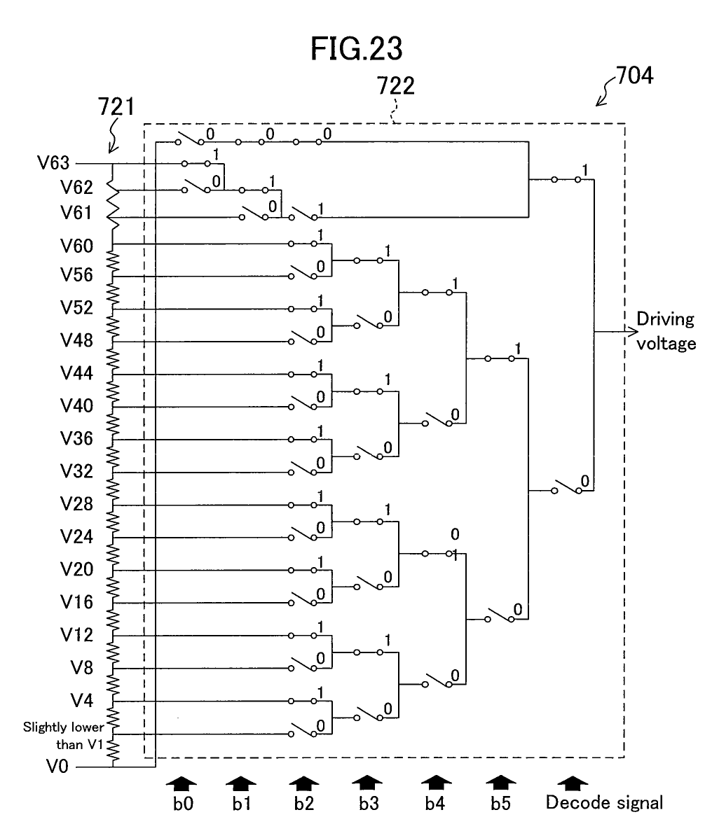

Specifically, as shown in FIG. 22, compared to Modified Example 4 of Embodiment 1, a driving device according to Embodiment 3 includes a data operation circuit 705 having a decoder 713, instead of the decoder 513, and a D/A converter 704 having a reference voltage generation circuit 721 and voltage selection sections 722 shown in FIG. 23.

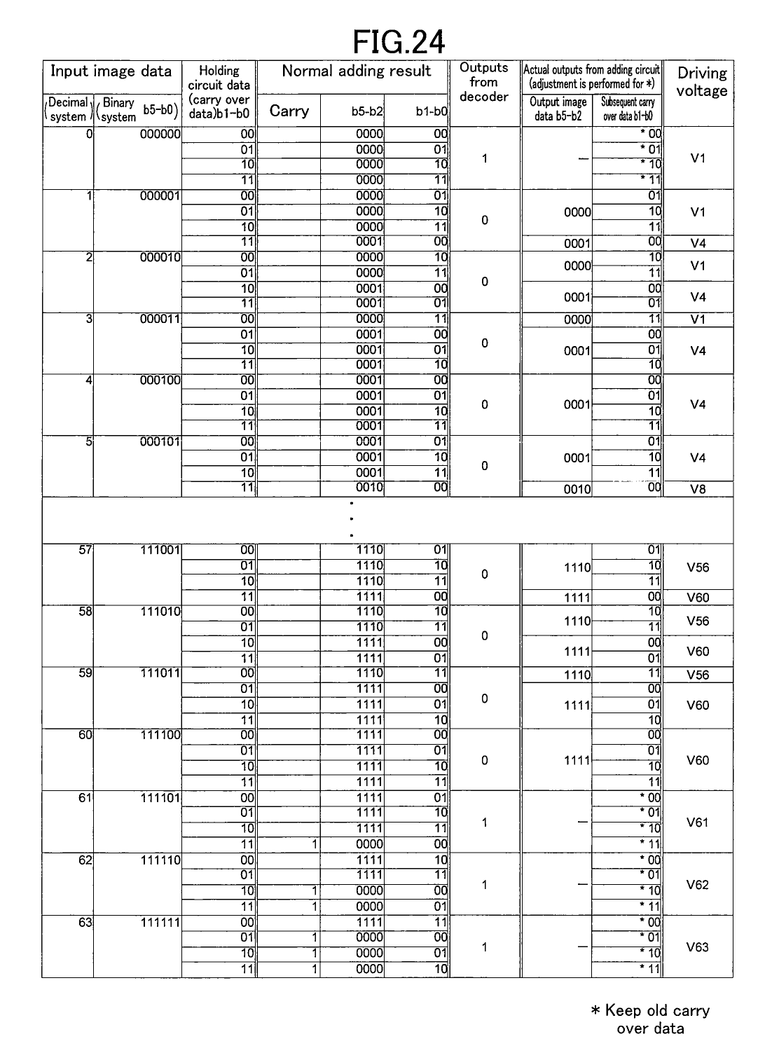

As shown in FIG. 24, the decoder 713 outputs a decode signal which becomes 1 when input image data is 0 or when input data is 61 or more. More specifically, for example, in addition to when high order 4 bits (b5 through b2) of the input image data are all 1 and one or both of low order 2 bits (b1 and b0) of the input image data are 1, the decoder 713 outputs 1 when 6 bits of the input image data are all 0.

The functions and operations of the adding circuit 511 and the holding circuit 512 are the same as those described in Modified Example 4 of Embodiment 1.

The D/A converter 704 selects one of reference voltages V61 through V63 in the same manner as in the D/A converter 504. In addition, when 6 bits of the input image data are all 0, the D/A converter 704 selects reference voltage V0 and, on the other hand, when high order 4 bits of an adding result are all 0, a slightly lower voltage than reference voltage V1.

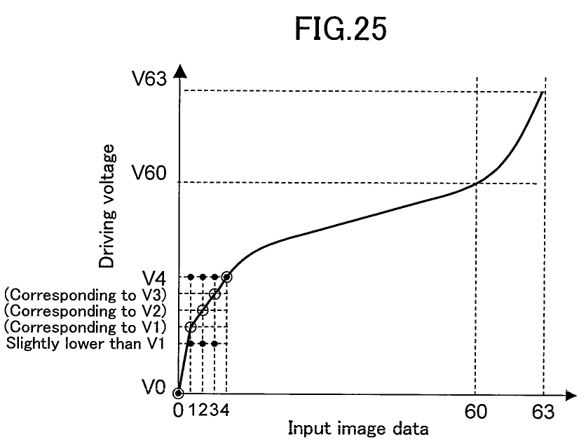

With the above-described configuration, as shown in FIG. 25, a driving voltage corresponding to a desired γ curve can be output for a pixel of which input image data is 0 through 4 in a simple manner, even when the γ curve has a small linearity, i.e., a gradient of the γ curve is large between V0 and V1 and small between V1 through V4.

The driving device may be configured to select, based on a value(s) of a low order bit or low order 2 bits of the input image data, a reference voltage corresponding to high gradation only for a certain gradation range, for example, where input image data is 0 through 4. In this case, compared to the case where selection is performed for an entire gradation range based on all bits of input image data, gradation can be partially increased using a largely reduced number of switches in a simple manner, thereby improving image quality.

### Embodiment 4

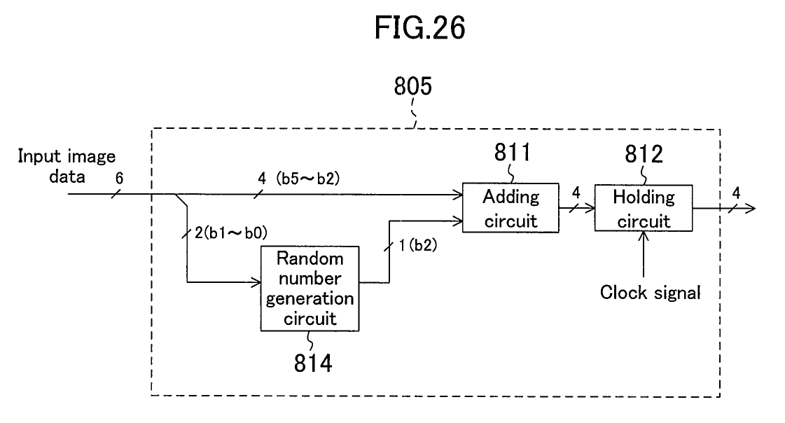

Instead of adding carry over data to image data, a random number may be added. Specifically, as shown in FIG. 26, the driving device of Embodiment 4 includes a data operation circuit 805 having an adding circuit 811, a holding circuit 812 and a random number generation circuit 814.

The random number generation circuit 814 outputs, when a value corresponding to low order 2 bits (b1 and b0) of input image data is one of 1 through 3, a random number which becomes 1 at a probability of ¼ through ¾ according to the value.

The adding circuit 811 adds the random number to high order 4 bits (b5 through b2) of the input image data.

The holding circuit 812 holds a result of the adding once, thereby outputting the result at appropriate timing.

Even in the driving device having the above-described configuration, for example, if input image data is 000001 (2), i.e., low order 2 bits is 01 (2), 0000 (2) is averagely output from the data operation circuit 805 for 3 out of 4 pixels and 0001 (2) is output for the other 1 of the 4 pixels. If the 4 pixels are located adjacent to one another, a display which looks like a display corresponding to gradation V1 is averagely (stochastically) performed.

### Embodiment 5

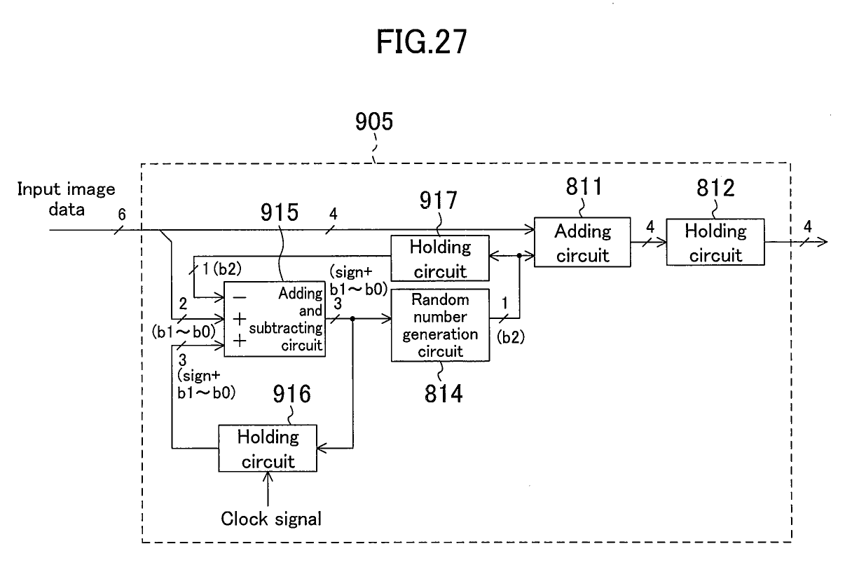

As a value of low order 2 bits for generating a random number, a cumulative value may be used. Specifically, as shown in FIG. 27, the driving device of Embodiment 5 includes a data operation circuit 905 having an adding/subtracting circuit 915, a holding circuit 916 and a holding circuit 917, in addition to the members of the configuration of Embodiment 4 (FIG. 26).

The adding/subtracting circuit 915 adds 3 bit data (carry over data of a signed number or two's complement) stored in the holding circuit 916 to low order 2 bits of input image data and subtracts a value output by the random number generation circuit 814 at the digit position of (b2).

The holding circuit 916 holds an adding result output from the adding/subtracting circuit 915 as subsequent carry over data.

The random number generation circuit 814 outputs, when an adding/subtracting result output from the adding/subtracting circuit 915 is one of 1 through 3, a random number which becomes 1 at a probability of ¼ through ¾ according to the value. For example, when the adding/subtracting result is 0 or lower, the random number generation circuit 814 always outputs 0 and, when the adding/subtracting result is 4 or more, the random number generation circuit 814 always outputs 1.

As described above, by using carry over data adding and a random number, even though a value of low order 2 bits of input image data is the same, the probability that after 1 is added to high order 4 bits, 1 is again added thereto is low, and the probability that 1 is not added to high order 4 bits and then 1 is added thereto is high. Accordingly, the probability that a display is averagely performed at an appropriate gradation within adjacent pixels is increased.

### Embodiment 6

An initial value of carry over data held by the holding circuit 112 and the like described in Embodiment 1 and the like may be a particular value such as 0 or may be a random number. Such an initial value may be set for each display line, and also carry over data for a last pixel of a previous line may be merely used, as it is, as an initial value for a subsequent line. That is, for example, in the case of a shot image where carry over data for a last pixel of a display line is close to random, the same effects as those in the case where a random number is used as an initial value can be achieved.

On the other hand, in the case of a computer image of which image data has periodicity, if respective initial values of display lines are the same, gradation of pixels located in the same lateral row becomes 1 level higher and thus a lateral stripe might be distinctive. In such a case, it is preferable to set a random number as each of the initial values.

For example, carry over data or output image data of a leading pixel may be obtained based on image data of a following pixel.

### Embodiment 7

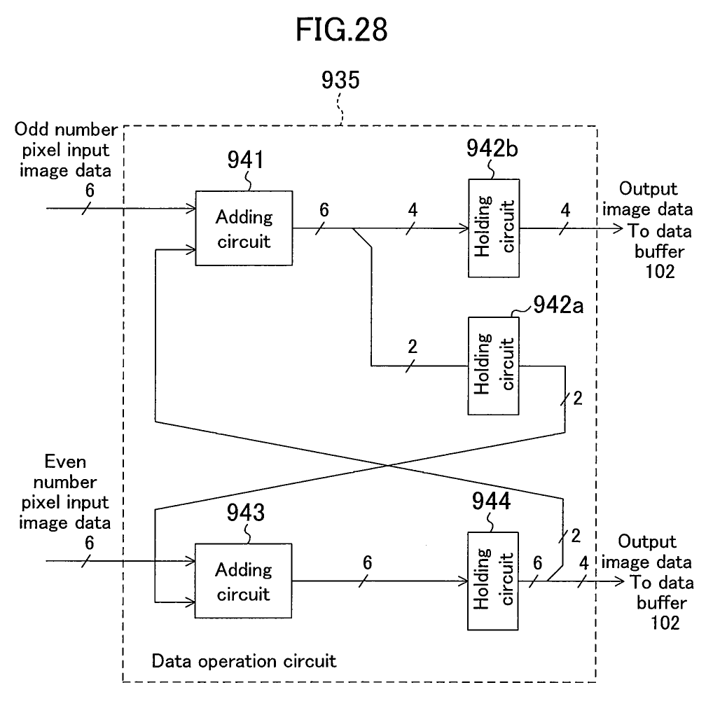

An exemplary driving device having a configuration in which image data input is performed such that image data for adjacent two pixels are received in parallel at each time and then driving voltages for the pixels are output will be described. In this example, image data of each pixel is serially received bit by bit. As shown in FIG. 28, a data operation circuit 935 of this driving device includes adding circuits 941 and 943 and holding circuits 942a, 942b and 944.

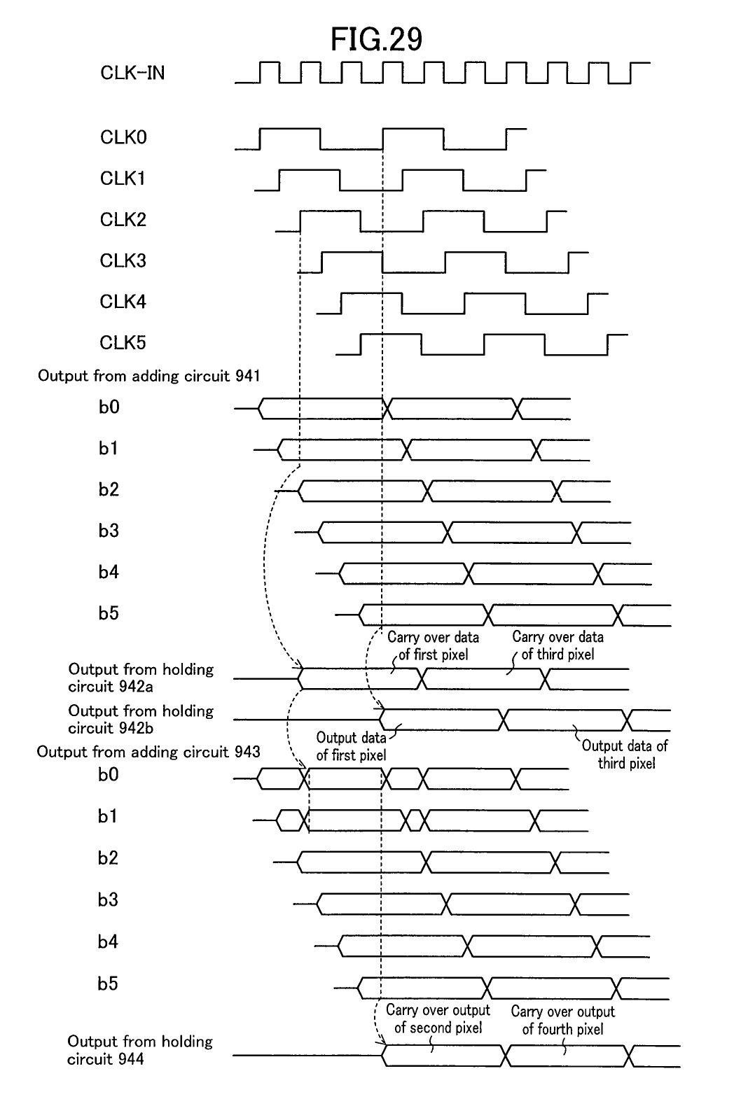

The adding circuit 941 receives input image data of odd number pixels at the serial. Then, as shown in FIG. 29, the adding circuit 941 sequentially holds 6 bit (b5 through b0) input image data in synchronization with clock signals CLK0 through CLK5 obtained by dividing an input clock signal CLK-IN and adds 2 bit carry over data held in the holding circuit 944. An adding result for each bit is sequentially output from the adding circuit 941 in synchronization with the clock signals CLK0 through CLK5. When a carry from a highest bit (b5) occurs at the time of adding, values of high order 4 bits (b5 through b2) of the adding result output from the adding circuit 941 are all 1 as in Embodiment 1.

Data (carry over data) of low order 2 bits (b1 through b0) of the adding result is held in the holding circuit 942a in synchronization with the clock signal CLK2 and output to the adding circuit 943. On the other hand, data (output data) of high order 4 bits (b5 through b2) is held in the holding circuit 942b in synchronization with the clock signal CLK0 and output to the data buffer 102.

In the adding circuit 943, input image data of even number pixels is serially received. Then, the adding circuit 943 sequentially holds 6 bit (b5 through b0) input image data in synchronization with the clock signals CLK0 through CLK5 and adds 2 bit carry over data held in the holding circuit 942a in synchronization with the clock signal CLK2.

An adding result for low order 2 bits (b1 through b0) output from the adding circuit 943 is determined in synchronization with the clock signal CLK2, and an adding result for high order 4 bits (b5 through b2) is determined in synchronization with the clock signals CLK2 through CLK5 as input image data is sequentially received. The determined adding results for all bits are held in the holding circuit 944 in synchronization with the clock signal CLK0. Then, carry over data of the low order 2 bits (b1 through b0) is output to the adding circuit 941 and output data of the high order 4 bits (b5 through b2) is output to the data buffer 102.

As described above, adding of one of the input data for two pixels received in parallel to carry over data and adding of a result of the adding to the other input data are performed in tandem, so that output image data for the two pixels can be output in parallel. Specifically, as described above, in the case where input image data is serially received, if an adding delay and a carry propagation delay for each image data after low order 2 bits of each input image data has been received are shorter than a time from a timing when the low order 2 bits of each input image data is input to a timing when subsequent input image data is received, influences of the adding delay and the carry propagation delay on an output timing of output image data can be avoided.

The driving device of this embodiment is not necessarily limited to the configuration in which the holding circuit 942a holds carry over data in synchronization with the clock signal CLK2 but, unless the adding delay and the carry propagation delay influence output timing of output image data, the holding circuit 942a may hold carry over data in synchronization with a later clock signal. Furthermore, the driving device may be configured so that if there is enough timing margin between input and output of input and output image data, after receiving input image data of all bits of each pixel, the holding circuits 942a and 942b hold adding results using the same clock signal and the holding circuit 944 holds an adding result by the adding circuit 943 at a timing when the adding result is determined.

Also, even in the case where image data of each pixel is serially received not only bit by bit but also in the manner in which all bits of the image data are received in parallel, if there is enough timing margin between input and output of input and output image data, adding results may be sequentially held at a timing when the adding results for each pixel are sequentially determined or adding results for all pixels may be held at the same time at a timing when the adding results of the all pixels are determined.

Moreover, if an adding result output from the adding circuit 941 is kept before an adding result output from the adding circuit 943 is held in the holding circuit 944, the holding circuit 942a does not have to be provided.

The number of pixels of which input image data are received parallel, the bit number of input and output image data, and the bit number of carry over data are not limited to those described above.

The above-described configuration may be combined with any one of Embodiments 1, 2, 3, 5, 6 and 8 and modified examples of these embodiments as appropriate. Specifically, for example, the adding circuit 941 and the holding circuits 942a and 944 may be configured to generate and hold a carry signal in the same manner as in Modified Example 3 (FIG. 10) of Embodiment 1, thereby combining the above-described configuration with the D/A converter 404 of FIG. 11.

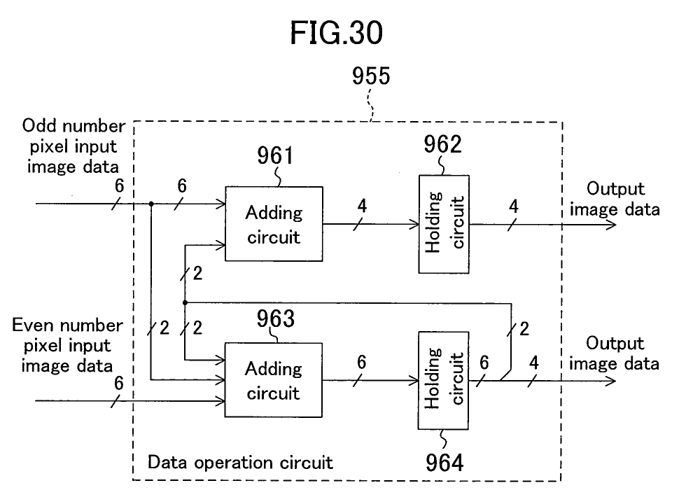

As described above, the driving device of this embodiment is not limited to the configuration in which low order bits of an adding result for each pixel is used as carry over data for adding for another pixel. Adding for a plurality of pixels may be performed in parallel. Specifically, for example, as shown in FIG. 30, if the driving device is configured, by using a data operation circuit 955 including adding circuits 961 and 963 and holding circuits 962 and 964, so that the adding circuit 961 adds input image data of a first pixel and carry over data from the holding circuit 964 and, on the other hand, the adding circuit 963 adds low order 2 bits of the input image data, the carry over data and input image data of a second pixel, output image data can be obtained by a substantially equivalent operation. In this case, although adding of three or more inputs is required for low order bits, respective output image data for pixels can be output at the same time in a simple manner.

### Embodiment 8

A driving device for driving an image display system may be formed of a single chip semiconductor. However, when a display line has a large number of pixels and the like, a driving device for driving a single display line may be configured so as to include a plurality of unit driving devices each of which is formed of a single chip semiconductor.

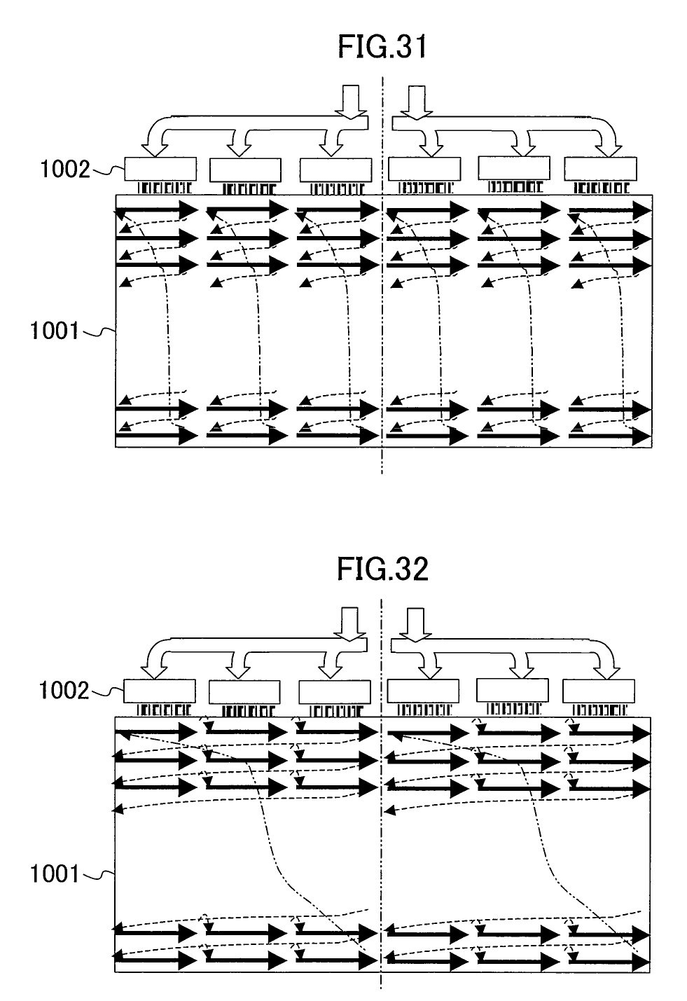

Specifically, for example, as shown in FIG. 31, a single image display panel 1001 may be driven by a driving device including six unit driving devices 1002. In the example of FIG. 31, the unit driving devices 1002 are separately connected three by three to buses and a start pulse signal, a clock signal and image data are sequentially given. Assume that the number of pixels per display line is M. Then, each of the unit driving devices 1002 receives image data corresponding to M/6 pixels in each display line each time a start pulse signal is received. In this case, as described in Embodiment 6, carry over data may be initialized each time a start pulse signal is received. However, as indicated by a broken line in FIG. 31, carry over data for last part of image data of M/6 pixels in each display line may be held as it is and used as an initial value in a subsequent display line. Moreover, as indicated by a two-dot chain line in FIG. 31, in the same manner, carry over data in a display line located at the bottom of a frame may be used as an initial value of carry over data located at a beginning of a subsequent frame.

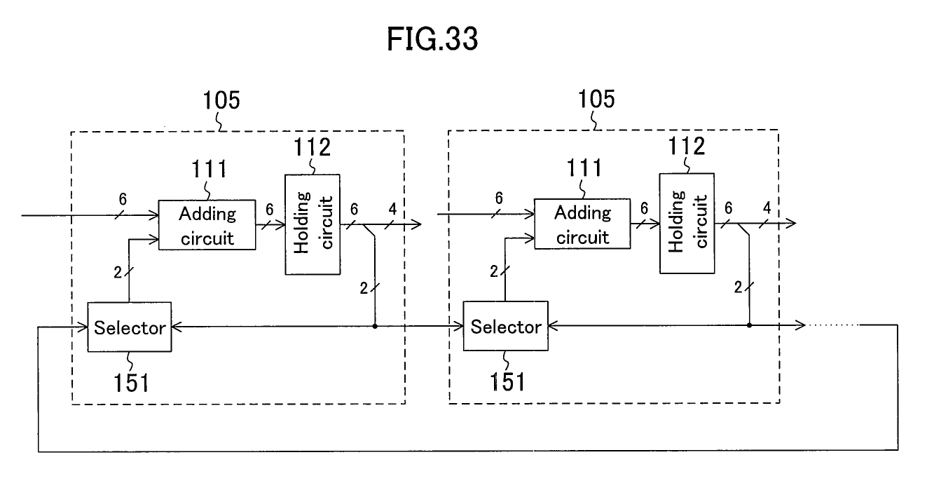

Moreover, for example, as indicated by a broken line and a two-dot chain line in FIG. 32, carry over data may be passed, for example, by three unit driving devices 1002 as a unit. More specifically, for example, the data operation circuit 105 of Embodiment 1 may be provided in the manner shown in FIG. 33 in which a selector 151 is further provided so that when a start pulse signal is received, carry over data held in the data operation circuit 105 in a previous stage is selected and input to the adding circuit 111.

Furthermore, the same carry over data may be passed throughout a single display line.

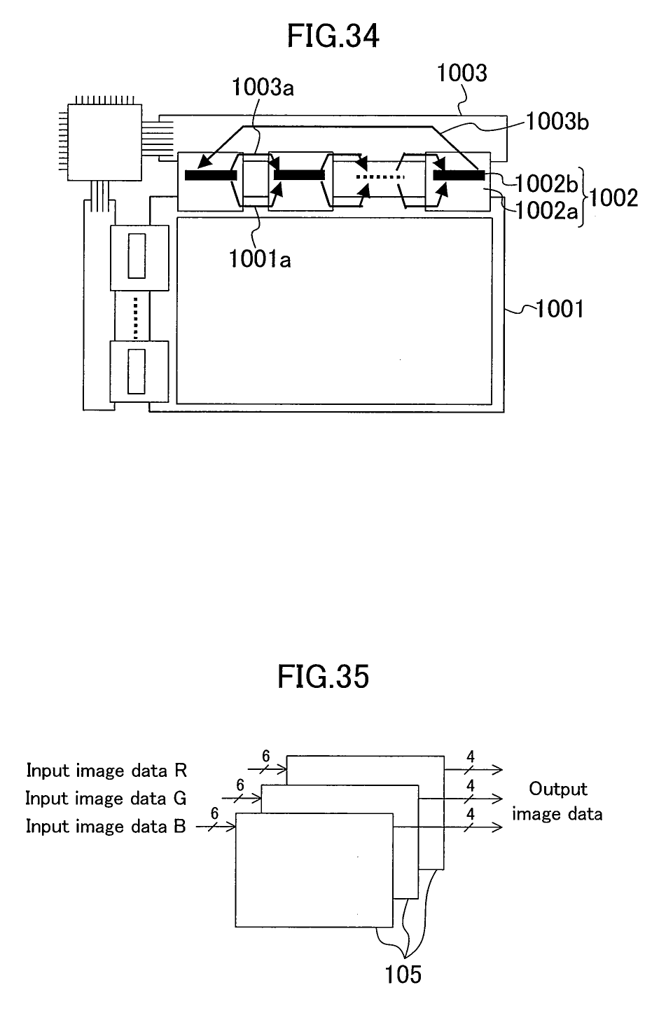

As described above, when carry over data is passed between the plurality of unit driving devices 1002, a configuration of interconnects for data passing is not particularly limited. However, for example, as shown in FIG. 34, when the plurality of unit driving devices 1002 formed by mounting semiconductor chips 1002b on a flexible substrate 1002a are used and a print interconnect substrate 1003 or the like for supplying image data or the like and the image display panel 1001 are connected with the plurality of unit driving devices 1002 interposed therebetween, carry over data may be passed between adjacent ones of the unit driving devices 1002 with an interconnect pattern 1001a formed on a glass substrate or the like of the image display panel 1001 or an interconnect pattern 1003a formed on the print interconnect substrate 1003 interposed therebetween. Moreover, in the same manner, carry over data may be passed from one of the unit driving devices 1002 corresponding to an end portion of a display line to another one of the unit driving devices 1002 corresponding to a start portion of another display line via an interconnect pattern formed on the image display panel 1001. However, in general, in terms of the degree of freedom of interconnect layout and the like, it is easier to form an interconnect pattern 1003b on the print interconnect substrate 1003.

<<Other Points>>

Each of the above-described configurations can be applied to a driving device for color display. Specifically, for example, when red image data, green image data and blue image data are received in parallel, as shown in FIG. 35, respective data operation circuits 105 and the like for three colors may be used as a group. When red image data, green image data and blue image data are sequentially received, respective image data of the three colors may be sorted to the data operation circuits 105 by a demultiplexer or the like. Moreover, the holding circuit 112 may be provided for each color, so that the provided holding circuits 112 can be sequentially switched and used.

Normally, it is desirable to carry over carry over data between adjacent pixels. However, if pixels are in the range in which a display is in a visually average gradation, carry over may be performed not only between adjacent ones of the pixels. Moreover, carry over of carry over data is not limited to pixels in a single display line but carry over data may be carried over between pixels in different display lines (in a longitudinal direction of a screen) by providing a line memory or the like or may be carried over between pixels in a two-dimensional range.

A gradation pattern which allows a display in an average gradation corresponding to a bit number of input image data may be achieved by using a plurality of pixels displayed, based on respective image data of the plurality of pixels. Not only the above-described carry over data adding but also function operation, table operation, filtering and the like may be used to achieve such a gradation pattern.

The present invention may be combined with a method such as the method disclosed in Japanese Laid-Open Publication No. 2000-183747 and Japanese Laid-Open Publication No. 2001-34234, in which a plurality of reference voltages are selected and averaged. Thus, gradation accuracy might be reduced due to averaging analog voltages, but a circuit size can be largely reduced in a simple manner.

As described above, in a driving device according to the present invention, accuracy of a driving voltage to be output from the driving device for driving an image display system can be kept high and also a circuit scale and an area thereof occupying in a semiconductor integrated circuit can be reduced in a simple manner.

What is claimed is:

1. A driving device for driving an image display system, which sequentially receives input image data corresponding to gradation of each pixel of a display image and outputs a driving voltage signal, the driving device comprising:
an operation section for obtaining output image data of which a bit number is smaller than a bit number of the input image data based on input image data of a target pixel to be processed and input image data of a pixel in vicinity of the target pixel;
a reference voltage generation section for generating a plurality of reference voltages of different levels; and
a reference voltage selection section for selecting one of the plurality of reference voltages,
wherein the operation section is configured to obtain output image data of the target pixel so that a difference between the input image data and output image data of the target pixel and a difference between the input image data and output image data of the pixel in vicinity of the target pixel cancel out each other.

2. The driving device of claim 1, further comprising a holding section for holding carry over data obtained when output image data of a previous pixel of the target pixel is obtained,
wherein the operation section adds the carry over data of the holding section to input image data, obtains a value of predetermined high order bits of an adding result as output image data and also makes the holding section hold a value of low order bits of the adding result as subsequent carry over data.

3. The driving device of claim 2, wherein the operation section obtains, when the adding result overflows, a maximum value of the high order bits is obtained as output image data.

4. The driving device of claim 3, wherein the operation section keeps, when the adding result overflows, the carry over data held in the holding section.

5. The driving device of claim 2, wherein a number of levels of the reference voltages is the high order bit power of 2.

6. The driving device of claim 1, further comprising a random number generation section for generating a random number according to a value of predetermined low order bits in input image data,
wherein the operation section adds the random number to high order bits in the input image data.

7. The driving device of claim 6, wherein the random number generation section generates the random number, based on a value obtained by subtracting a value corresponding to a generated random number for a previous pixel, from an adding value of predetermined low order bits of input image data which is sequentially received.

8. The driving device of claim 1, wherein the operation section obtains the output image data for at least one of parts into which a range of the input image data have been divided.

9. The driving device of claim 2, further comprising a plurality of unit driving devices for outputting a driving voltage signal for pixels of each of partial lines into which a display line has been divided, each of the unit driving devices including the operation section, the reference voltage section, the reference voltage selection section and a holding section.

10. The driving device of claim 9, wherein each of the operation sections obtains, based on carry over data obtained for a last pixel of each partial line in a first display line, output image data for an initial pixel of each partial line in a second display line.

11. The driving device of claim 10, wherein each of the operation sections further obtains, based on carry over data obtained for the last pixel of each last partial line of a frame, output image data for an initial pixel of each initial partial line of a subsequent frame.

12. The driving device of claim 9, wherein each of the operation sections obtains, based on carry over data obtained by another one of the unit driving devices for a last pixel of a previous partial line, output image data for an initial pixel of a subsequent partial line in the same display line as the previous partial line.

13. The driving device of claim 12, wherein the operation section of one of the unit driving devices obtaining output image data for an initial pixel of each display line obtains, based on carry over data obtained by another one of the unit driving devices for a last pixel of a previous display line, output image data for an initial pixel of a subsequent display line.

14. The driving device of claim 13, wherein the operation section of said one of the unit driving devices obtaining the output image data for the initial pixel of each display line further obtains, based on carry over data obtained for a last pixel of a last display line of a frame, output image data for an initial pixel in an initial display line of a subsequent frame.

15. The driving device of claim 12, wherein an interconnect pattern in which a display system substrate forming the image display system and an interconnect substrate for supplying input image data are connected to each other with the plurality of unit driving devices interposed therebetween and which transfers carry over data obtained by said another one of the unit driving devices for the last pixel of the previous partial line is formed at least on one of the display system substrate and the interconnect substrate.

16. The driving device of claim 13, wherein an interconnect pattern in which a display system substrate forming the image display system and an interconnect substrate for supplying input image data are connected to each other with the plurality of unit driving devices interposed therebetween and which transfers carry over data obtained by said another one of the unit driving devices for the last pixel of the previous display line is formed at least on one of the display system substrate and the interconnect substrate.

17. The driving device of claim 1, wherein the operation section receives image data for a plurality of pixels located adjacent to one another,
adds carry over data obtained when output image data of a first pixel of the plurality of pixels to input image data of a second pixel located adjacent to the first pixel to obtain a value of predetermined high order bits of an adding result as output image data of the second pixel, and
obtains a value of low order bits of the adding result as subsequent carry over data.

18. The driving device of claim 17, further comprising a holding section for holding carry over data for a pixel of the plurality of pixels located at an end portion,
wherein the operation section adds the carry over data held in the holding section to image data of one of a plurality of pixels which are received subsequently to the plurality of pixels located in a start portion.

19. The driving device of claim 17, wherein the operation section serially receives a value of each bit in image data of each pixel, holds the value of each bit and adds carry over data.

20. The driving device of claim 17, wherein the operation section obtains, when the adding result overflows, a maximum value of the high order bits is obtained as output image data.

21. The driving device of claim 1, wherein the operation section receives respective image data of a plurality of pixels located adjacent to one another,
adds carry over data used when obtaining output image data of a first pixel of the plurality of pixels, input image data of the first pixel and input image data of a second pixel located adjacent to the first pixel, and
obtains a value of predetermine high order bits of an adding result as output image data of the second pixel.
